(19) United States
(12) Patent Application Publication
(10) Pub. No.: US 2026/0208949 A1
(43) Pub. Date: Jul. 23, 2026

(54) METHOD, SYSTEM AND COMPUTER PROGRAM PRODUCT FOR MOVING A STORAGE CONTAINER

(71) Applicant: AutoStore Technology AS, Nedre Vats (NO)

(72) Inventors: Vegard Syre-Aaker, Asker (NO); Torgeir Lilleskog, Aksdal (NO)

(21) Appl. No.: 19/140,101

(22) PCT Filed: Dec. 19, 2023
(86) PCT No.: PCT/EP2023/086698

§ 371 Date: Jun. 17, 2025

(30) Foreign Application Priority Data
Dec. 23, 2022 (NO) 20221406

(51) Int. Cl. B65G 1/04; G06Q 10/083

(52) U.S. Cl. CPC B65G 1/0464; G06Q 10/083

(57) ABSTRACT

The invention relates to a system, method and computer program product for moving a storage container. The method comprising assigning a task to a container handling vehicle to retrieve a storage container (106) from a storage column and deliver the storage container (106) to the port area (510) of an access station. Instructing the container handling vehicle to retrieve the storage container (106) from the storage column. Determining a virtual buffer position (610) on the rail system between the storage column and the port area (510). Instructing the container handling vehicle to move the storage container (106) towards the virtual buffer position (610) on the rail system. Repeatedly receiving data of a current position of the storage container (106) on the rail system and a current availability of the access station. Instructing the container handling vehicle to move the storage container (106) to a column (119, 120) of the port area (510) if the current position of the storage container (106) is different from the virtual buffer position (610) and the column (119, 120) of the port area (510) is available, and instructing the container handling vehicle to deliver the storage container (106) into the column of the port area (510).

### FIELD OF THE INVENTION

The present invention relates to an automated storage and retrieval system for storage and retrieval of containers, in particular to a method, system and computer program product for moving a storage container.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b, 401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO 2014/090684A1 or WO 2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

FIG. 5 is a schematic top view of a prior art rail of an automated storage and retrieval system 1, as illustrated in FIG. 1. FIG. 5 shows the rail system 108, the storage columns 105, the port columns 119, 120 and a storage container 106 positioned in one of the storage columns 105. The port columns 119, 120 are part of an port area 510 of an access station, that as explained above, is a position on the automated storage and retrieval system 1 where product items are removed from or positioned into the storage containers 106. The access station may be positioned at the base of the port columns 119, 120. A container handling vehicle 201,301,401 delivering a storage container 106 to the port column 119, 120 moves towards the port column such that the storage container 106 enters the port column, and delivers the storage container to the access station by lowering the storage container 106 through the port column 119, 120.

The access station may also be positioned at the top of the port columns 119, 120. This may be the case if the access station is a robotic picking station, such as described in WO 2016/198565A1. Here the container handling vehicle 201,301,401 moving towards the port column 119, 120, and delivers the storage container to the access station by either lowering the storage container 106 through the port column 119, 120 to a level immediately below the rail system 108, e.g. Z=1, or by lowering the storage container 106 on the port column 119, 120 above the rail system 108, i.e. Z=0.

Also shown in FIG. 5, the port area 510 of the access station, may comprise two buffer columns 519, 520, adjacent the port columns 119, 120. The buffer columns 519, 520 are temporary positions for the container handling vehicles 201,301,401 to hold storage containers 106.

The buffer columns 519, 520, are used to plan for container handling vehicles 201,301,401 to move towards the port column 119, 120 early enough to meet a delivery time. To get maximum performance and flow in an access station, container handling vehicles 201,301,401 should arrive to the buffer column 519, 520 before the previous container handling vehicle 201,301,401 is finished in the port column 119, 120 of the access station. When the previous container handling vehicle 201,301,401 is finished in the port column 119, 120 and moves away, the next container handling vehicle 201,301,401 holding its storage container 106 in the buffer columns 519, 520 would be ready to move into the previous container handling vehicle's place without unnecessary wait. Waiting too long with a container handling vehicle 201,301,401 at a buffer column 519, 520 can waste container handing vehicle resources. Thus, the central control system 500 may make a determination to deliver the storage container 106 in the buffer column 519, 520.

A storage container 106 should arrive at the port area 510 of the access station just in time. Waiting for a storage container 106 decreases the performance of the access station (commonly measured in storage containers/hour). If a storage container 106, that is planned to be transported toward the port area 510, is in a position on the rail system 108 so far away from the port area 510 that it will not arrive in port area 510 before it was planned to be delivered, there will be a delay in the access station.

Since each buffer column 519, 520 replaces a storage column 105 of the automated storage and retrieval system 1, each access station has a limited number of buffer columns 519, 520 available to receive storage containers. The limited number of buffer columns 519, 520 limits the number of storage containers 106 that may be planned/moved towards the port area 510 of the access station.

There is a need for a system and method that increases the performance of the access station.

### SUMMARY OF THE INVENTION

The present invention is set forth and characterized in the independent claims, while the dependent claims describe other characteristics of the invention.

In one aspect, the invention relates to a method for moving a storage container with one of a plurality container handling vehicles on a rail system arranged at least partially across a framework structure of an automated storage and retrieval system, on which rail system the plurality of container handling vehicles are operable to retrieve storage containers from, and deliver storage containers into, storage columns arranged in rows between upright members of the framework structure, and moving the storage containers to and from a port area of an access station, and where the following steps are performed by a central control system which is in communication with the access station and a local controller in each of the plurality of container handling vehicles:
assigning a task to one of plurality of the container handling vehicles to retrieve a storage container from one of the storage columns and deliver the storage container to the port area;
instructing the container handling vehicle to retrieve the storage container from the one of the storage columns;
determining a virtual buffer position on the rail system between the storage column and the port area;
instructing the container handling vehicle to move the storage container towards the virtual buffer position on the rail system;
repeatedly receiving data of a current position of the storage container on the rail system and a current availability of the access station;
instructing the container handling vehicle to move the storage container to a column of the port area if the current position of the storage container is different from the virtual buffer position and the column of the port area is available; and
instructing the container handling vehicle to deliver the storage container into the column of the port area.

An advantage of the first aspect of the invention is that it reduces wait time in the access station for storage containers with long travel distances to the access station, effectively increasing the performance of the access station (storage container/hour). Another advantage of the first aspect of the invention is that the virtual buffer positions may reduce the number of required buffer columns. Reducing the number of required buffer columns between access stations may allow the access stations to be positioned closer to one another.

In one embodiment of the first aspect, the step of determining the virtual buffer position on the rail system comprises defining the virtual buffer position as any storage column within a first predetermined radius of one of the columns of the port area as the virtual buffer position.

In one embodiment of the first aspect, the step of determining the virtual buffer position on the rail system comprises selecting a storage column close to the port area to be the virtual buffer position, wherein the storage column is one having space to receive the storage container.

In one embodiment of the first aspect, the step of determining the virtual buffer position on the rail system comprises selecting the storage column closest to the port area having space to receive the storage container to be the virtual buffer position.

In one embodiment of the first aspect, the method comprises
instructing the container handling vehicle to move to a column of the access station if the current position of the storage container is in the virtual buffer position, and the column of the port area is available; and
instructing the container handling vehicle to deliver the storage container into the column of the access station.

In one embodiment of the first aspect, the method comprises determining, if the current position of the storage container is in the virtual buffer position and the access station is not available, to instruct the one of the plurality of container handling vehicles to deliver the storage container into the virtual buffer position.

In one embodiment of the first aspect, the method comprises determining, if the current position of the storage container is in the virtual buffer position and the access station is not available, to instruct the one of the plurality of container handling vehicles to deliver the storage container into a virtual buffer position other than the virtual buffer position.

In one embodiment of the first aspect, the method comprises determining to instruct the one of the plurality of container handling vehicles to deliver the storage container into the virtual buffer position when a deadline to deliver the storage container into the virtual buffer position when a deadline to deliver the storage container into a column of the port area exceeds a deadline threshold.

In one embodiment of the first aspect, the method comprises determining to instruct the one of the plurality of container handling vehicles to deliver the storage container into the virtual buffer position when the access station has been idle for a time exceeding an idle threshold.

In a second aspect, the invention concerns an automated storage and retrieval system comprising:
a framework structure comprising upright members arranged at least partially across the framework structure;
storage columns arranged in rows between the upright members of the framework structure;
an access station comprising a port area;
a plurality of container handling vehicles operable to retrieve storage containers from, and deliver storage containers into, the storage columns and moving the storage containers to and from the port area of the access station, each of the plurality of container handling vehicles comprising a local controller;
a central control system operable to be in communication with the access station and the local controller in each of the plurality of container handling vehicles, the central control system adapted to
   assign a task to one of the plurality of container handling vehicles to retrieve a storage container from one of the storage columns and deliver the storage container to the port area;
   instructing the container handling vehicle to retrieve the storage container from the one of the storage columns;
   determine a virtual buffer position on the rail system between the storage column and the port area;
   instruct the container handling vehicle to move the storage container towards the virtual buffer position;
   repeatedly receive data of a current position of the storage container on the rail system and a current availability of the access station;
   instruct the container handling vehicle to move the storage container to a column of the port area if the current position of the storage container is different from the virtual buffer position and the column of the port area is available; and
   instruct the container handling vehicle to deliver the storage container into the column of the port area.

An advantage of the second aspect of the invention is that it reduces wait time in the access station for storage containers with long travel distances to the access station, effectively increasing the performance of the access station (storage container/hour). Another advantage of the first aspect of the invention is that the virtual buffer positions may reduce the number of required buffer columns. Reducing the number of required buffer columns between access stations may allow the access stations to be positioned closer to one another.

In one embodiment of the second aspect, the system is adapted to determine the virtual buffer position on the rail system by defining the virtual buffer position as any storage column within a first predetermined radius of one of the columns of the port area as the virtual buffer position.

In one embodiment of the second aspect, the system is adapted to determine the virtual buffer position on the rail system by selecting a storage column close to the port area to be the virtual buffer position, wherein the storage column is one having space to receive the storage container.

In one embodiment of the second aspect, the system is adapted to determine the virtual buffer position on the rail system by selecting the storage column closest to the port area having space to receive the storage container to be the virtual buffer position.

In one embodiment of the second aspect, the system is adapted to
instruct the container handling vehicle to move to a column of the access station if the current position of the storage container is in the virtual buffer position, and the column of the port area is available; and
instruct the container handling vehicle to deliver the storage container into the column of the access station.

In one embodiment of the second aspect, the system is adapted to determine, if the current position of the storage container is in the virtual buffer position and the access station is not available, to instruct the container handling vehicle to deliver the storage container into the virtual buffer position.

In one embodiment of the second aspect, the system is adapted to determine, if the current position of the storage container is in the virtual buffer position and the access station is not available, to instruct the container handling vehicle to deliver the storage container into a virtual buffer position other than the virtual buffer position.

In one embodiment of the second aspect, the system is adapted to instruct the container handling vehicle to deliver the storage container into the virtual buffer position when a deadline to deliver the storage container into a column of the port area exceeds a deadline threshold.

In one embodiment of the second aspect, the system is adapted to instruct the container handling vehicle to deliver the storage container into the buffer position when the access station has been idle for a time exceeding an idle threshold.

In a third aspect the invention is directed to a computer program product for the central control system of the second aspect of the invention, wherein the computer program product comprises instructions that when performed on the control system performs the method of the first aspect of the invention.

The third aspect of the invention has the same advantages as the first and second aspects of the invention.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a schematic illustration of a prior art automated storage and retrieval system. FIG. 6 is a schematic illustration of embodiments of the present invention.

FIG. 7 is a schematic illustration of embodiments of the present invention.

FIG. 8 is a flowchart of a method according to an embodiment of the present invention.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

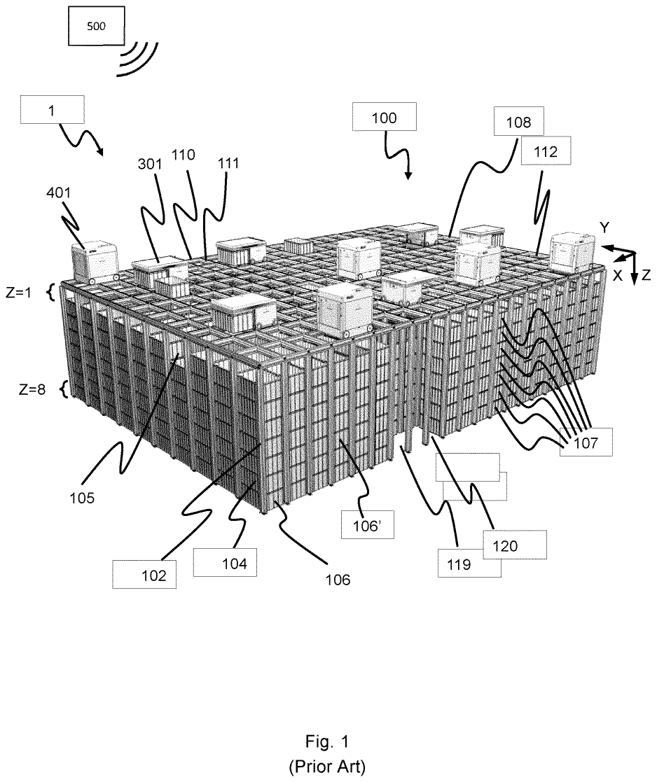

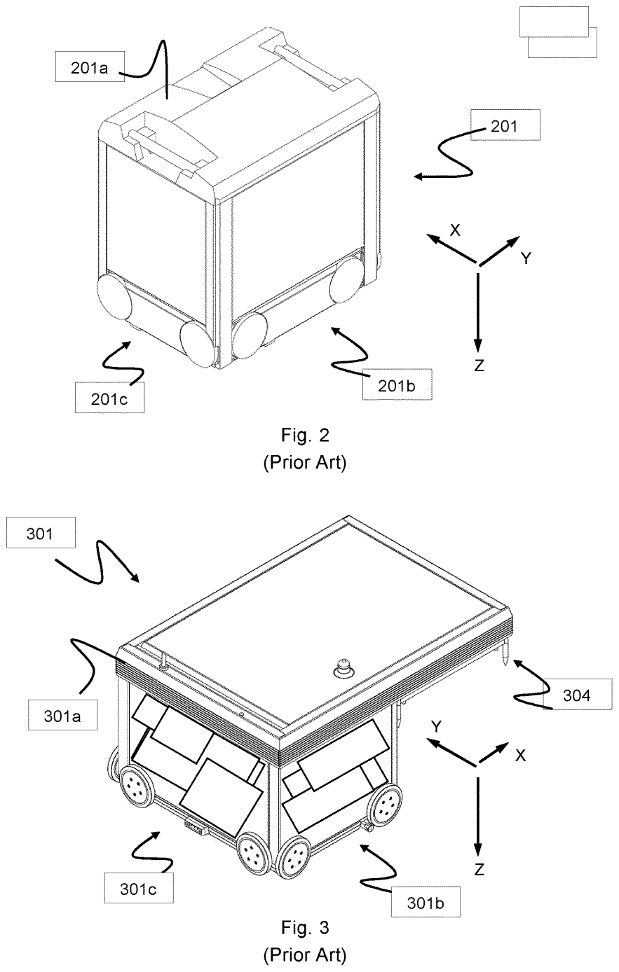

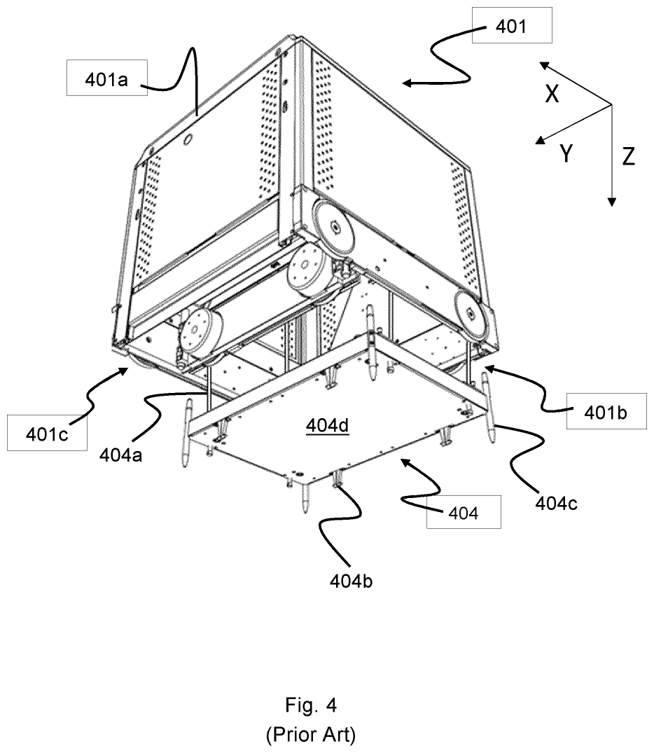

The framework structure 100 of the automated storage and retrieval system 1 is constructed in a similar manner to the prior art framework structure 100 described above in connection with FIGS. 1-5. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

One embodiment of the automated storage and retrieval system according to the invention will now be discussed in more detail with reference to FIGS. 6-8.

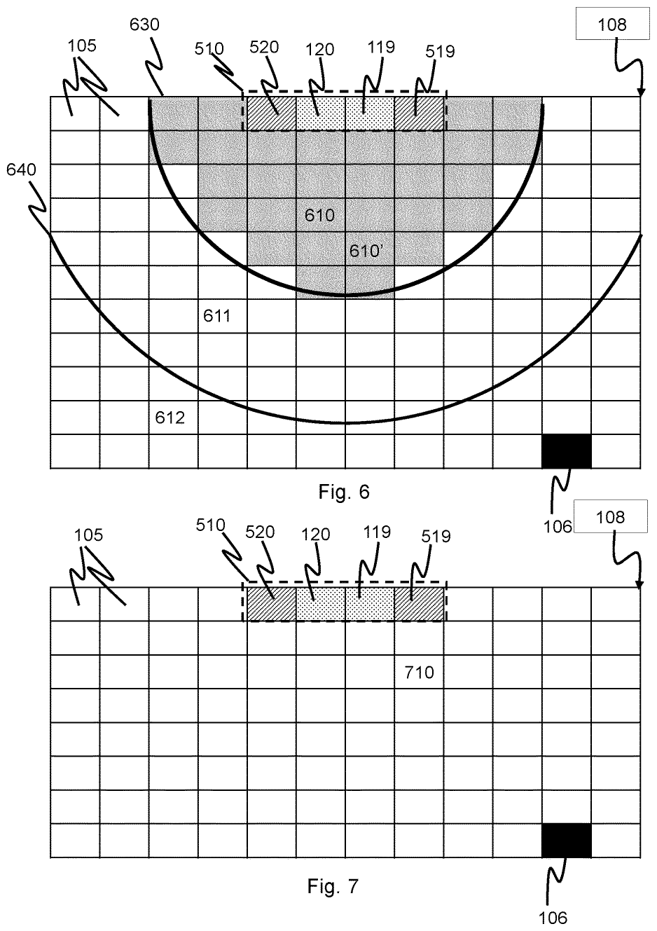

FIG. 6 and FIG. 7 are schematic illustrations of a rail system 108 arranged at least partially across a framework structure of an automated storage and retrieval system, on which rail system 108, a plurality of container handling vehicles are operable to retrieve storage containers 106 from, and deliver storage containers into, storage columns 105 arranged in rows between upright members (and optionally horizontal members) of the framework structure, and move the storage containers 106 to and from an port area 510 of an access station. The port area 510 is represented by two port columns 119, 120 and two buffer columns 519, 520 adjacent the port columns 119, 120.

The number of port columns 119, 120 in the port area 510 may vary based on the type of access station. One type of access station has one port column 119, 120 used both to retrieve and deliver storage containers. Another type of access station has several port columns 119, 120, where some of the port columns 119, 120 are provided to retrieve storage containers 106 and other port columns 119, 120 are provided to deliver storage containers 106. Other types of access station may have fewer or more several port columns 119, 120, where some or all the port columns 119, 120 may be used both to retrieve and deliver storage containers 106.

The optional buffer columns 519, 520 adjacent the port columns 119, 120 allow a container handling vehicle 106 to be ready to move into a port column 119, 120 immediately after a previous container handling vehicle moves out of the port column 119, 120. Each access station has a limited number of buffer columns 519, 520, typically one or two buffer columns 519, 520 for each port column 119, 120. The buffer columns 519, 520 may have space to receive a container handling vehicle 106. For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a central control system 500 which comprises a database for keeping track of the storage containers 106. The central control system 500 is also in communication with the access station and receives information from the access station about the status of the port columns 119, 120 and buffer columns 519, 520 adjacent the port columns 119, 120. The status may comprise information about the presence of storage containers 106 in the columns 119, 120, 519, 520 of the access station, for example, when a storage container 106 is ready to be returned to a storage column 105, etc. The central control system 500 performs the planning of which storage containers 106 should be moved to the access station at any time, it determines when a storage container 106 has to be picked up by a container handling vehicle 201,301,401 for the storage container 106 to arrive at the access station in time, and calculates a route for the storage container 106 to travel towards the columns 119, 120, 519, 520 of the port area 510 of the access station. The central control system performs all these tasks for a plurality of container handling vehicles 201,301,401 at the same time and repeats the calculations as often as necessary.

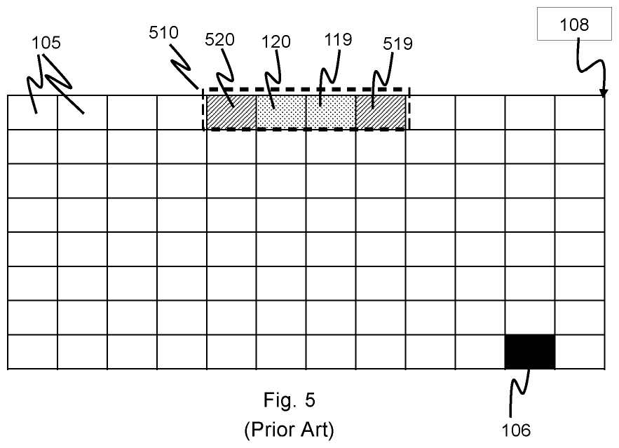

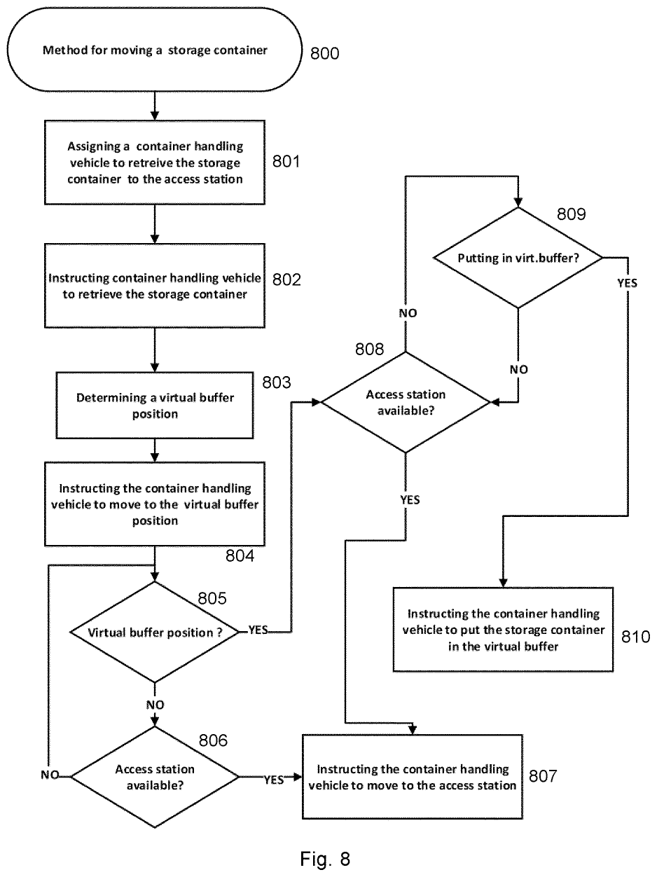

In the prior art, such as described with reference to FIG. 5, the central control system 500 would not have moved a storage container 106 towards the port area 510 of the access station without a valid target position, i.e. an available port column 119, 120, or if the delivery is within a predetermined time and the port column is occupied, an available buffer column 519, 520. When the central control system 500 had a storage container 106 on a container handling vehicle 201,301,401 scheduled for the port area 510, it checked if the storage container 106 was too far away from the port area 510 to be there on time. The central control system 500 would then instruct the container handling vehicle 201,301,401 to deliver the storage container 106 to a storage column 105 closer to the port area 510. The goal being to move storage containers 106 that are far away and put them closer to the port area 510 early. The container handling vehicle 201,301,401 would then be assigned to another task, and the storage container 106, now in a position closer to the port area 510 would be assigned to another container handling vehicle 201,301,401 to move to the port area 510 at a later time. In one embodiment of the present invention, the central control system 500 allows movement of a storage container 106 towards the port area 510 without an available port or buffer column 119, 120, 519, 520 of the port area 510, and allows routing of the storage container 106 via a temporary target position, or virtual buffer position 610, 710 on the rail system 108 FIG. 8 is an exemplary flow chart of a method 800 according to an embodiment of the present invention. The method 800 is performed by the automated storage and retrieval system 1 described with reference to the figures, in particular FIG. 1, FIG. 6, and FIG. 7.

In a first step 801, the central control system 500, assigns a task to one of the plurality of container handling vehicles 201, 301, 401 to retrieve a storage container 106 from one of the storage columns 105 and deliver the storage container 106 to the port area 510. The assignment may be performed as part of a routing optimizing process involving a plurality of storage container handling vehicles 201, 301, 401 and a plurality of storage containers 106. The routing optimizing process may use an A* algorithm.

In a next step 802, the central control system 500, instructs the storage container handling vehicle 201, 301, 401 to retrieve the storage container 106 from the storage column 105.

In a next step 803, that may be integrated with the routing optimizing step of the first step 801, the central control system 500, determines av virtual buffer position 610, 710 on the rail system 108 between the storage column 105 and the port area 510.

In one embodiment, as illustrated in FIG. 6, the step of determining the virtual buffer position on the rail system comprises defining the virtual buffer position 610 as any storage column 105 within a first predetermined radius 530 of one of the columns 119, 120, 519, 520 of the port area 510 as the virtual buffer position 610. In this case the routing optimizing process optimizes the route for any storage column 105 within a first predetermined radius 530 of the column 119, 120, 519, 520 as the target position.

In one embodiment, as illustrated in FIG. 7, the step of determining the virtual buffer position on the rail system 108 comprises selecting a storage column 105 close to the port area 510 to be the virtual buffer position 710, wherein the storage column 105 is one having space to receive the storage container 106. Close to the port area 510 may be assessed on a temporal basis (e.g., ‘temporal close’) or on a spatial basis (e.g., ‘spatial close’). In this case the routing optimizing process optimizes the route for the virtual buffer position 710 as the target position.

In one embodiment, as also illustrated in FIG. 7, the step of determining the virtual buffer position on the rail system 108 comprises selecting the storage column 105 closest to the port area 510 having space to receive the storage container 106 to be the virtual buffer position 710. Closest to the port area 510 may be assessed on a temporal basis (e.g., ‘temporal close’) or on a spatial basis (e.g., ‘spatial close’). In this case the routing optimizing process optimizes the route for the virtual buffer position 710 as the target position.

In a next step 804, the central control system 500, instructs the container handling vehicle 201, 301, 401 to move the storage container 106 towards the virtual buffer position 610, 710 that has been selected.

In next steps 805 and 806, while the container handling vehicle 201, 301, 401 is moving the storage container 106 towards the virtual buffer position 610, 710, the central control system 500 is repeatedly receiving data of a current position of the storage container 106 and/or the container handling vehicle 201, 301, 401 on the rail system 108 and a current availability of the access station. These steps may be integrated with the routing optimizing step of the first step 801 and are performed as often as necessary.

The database of the central control system 500 has knowledge of the position of all storage containers 106. The central control system 500 is also informed by the access station when a storage container 106 is ready to be retrieved from a port column 119, 120 of the port area 510 of the access station.

If the current position of the storage container 106 is different from the virtual buffer position 610, 710, and a column 119, 120, 519, 520 of the port area 510 is available, the central control system 500 instructs the container handling vehicle 201, 301, 401 carrying the storage container 106 to move the storage container 106 to a port column 119, 120 or a buffer column 519, 520. That is, the storage container 106 is rerouted from the virtual buffer position 610, 710 when the port area 510 of the access station become available while the storage container 106 is moving towards the virtual buffer position 610, 710. Once the storage container 106 is in the port area 510 of the access station, the central control system 500 instructs the container handling vehicle 201, 301, 401 to deliver the storage container 106 into one of the columns 119, 120, 519, 520 of the port area 510 of the access station. The container handling vehicle 201, 301, 401 would then deliver the storage container 106 to the column 119, 120, 519, 520 and move away to be assigned to other tasks.

In the case the storage container 106 is in the virtual buffer position 610, 710 before the port area 510 is available, the next step 808 is to wait at the virtual buffer position 610, 710 for the port area 510 to be available, that is, the steps of instructing the container handling vehicle 201, 301, 401 to move to a column 119, 120, 519, 520 of the port area 510 if the current position of the storage container 106 is in the virtual buffer position 610, 710, and the column 119, 120, 519, 520 of the port area 510 is available, and instructing the container handling vehicles 201, 301, 401 to deliver the storage container 106 into the column 119, 120, 519, 520 of the port area 510. These steps may be integrated with the routing optimizing step of the first step 801 and are performed as often as necessary.

In the case the virtual buffer position 610 is within the first predetermined radius 530 of the column 119, 120, 519, 520 of the port area 510, there is a plurality of available virtual buffer positions 610. Since the routing optimizing step are performed frequently, it is likely that the container handling vehicle 201, 301, 401 holding the storage container 106 will move around. In one embodiment, the storage container 106 is allowed to move outside the first predetermined radius 530 of the column 119, 120, 519, 520 of the port area 510 into a virtual buffer position 611 within a second predetermined radius 540 of the column 119, 120, 519, 520 of the port area 510. The container handling vehicle 201, 301, 401 is instructed to move the storage container 106 to a virtual buffer position within the first predetermined radius 530 once the storage container is in a position 612 outside the second predetermined radius 540. Waiting too long with a storage container 106 in the container handling vehicle 201, 301, 401 in the virtual buffer position 610, 710 wastes container handling vehicle resources, and unnecessary wait should be avoided.

In step 809, the central control system 500, if the current position of the storage container 106 is in the virtual buffer position 610, 710 and the access station is not available, instructs the container handling vehicle 201, 301, 401 to deliver the storage container 106 into the virtual buffer position 610, 710. The storage container 106 is then stored in the storage column 105 below the virtual buffer position 610, 710 designated on the rail system, or on the virtual buffer position 610, 710 if the container handling vehicle is depositing the storage container 106 on the level of the rail system (z=0).

In the case the virtual buffer position 610 is within the first predetermined radius 530 of the column 119, 120, 519, 520 of the port area 510, there is a plurality of available virtual buffer positions 610. Since the routing optimizing step are performed frequently, it is likely that the container handling vehicle 201, 301, 401 holding the storage container 106 will move around. In step 809, the control system 500, if the current position of the storage container 106 is in the virtual buffer position 610 and the access station is not available, instructs the one container handling vehicle 201, 301, 401 to deliver the storage container 106 into a virtual buffer position 610′, 611, 612.

In one embodiment, the step 809 of instructing the container handling vehicle 201, 301, 401 to deliver the storage container 106 into the virtual buffer position 610, 610′, 611, 612, 710 when a deadline to deliver the storage container 106 into a column 119, 120, 519, 520 of the port area 510 exceeds a deadline threshold.

In one embodiment, the step 809 of determining to instruct the container handling vehicle 201, 301, 401 to deliver the storage container 106 into the virtual buffer position 610, 610′611, 612, 710 when the access station has been idle for a time exceeding an idle threshold. The idle threshold may be determined automatically by the central control system 500 based on statistical analysis of the automated storage and retrieval system 1.

In one embodiment, the present invention may be provided in the form of a computer program product for the central control system 500. The computer program product comprises instructions that when performed on the central control system performs the step of the method 800.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction
510 Port area of access station
519 First buffer column
520 Second buffer column
610 Virtual buffer position
610′ Virtual buffer position
61 Virtual buffer position
613 Return to virtual buffer position 610
710 Virtual buffer position
800 Method for moving a storage container
801 Assigning a container handling vehicle to retrieve storage container to the access station
802 Instructing the container handling vehicle to retrieve the storage container
803 Determining a virtual buffer position
804 Instructing the container handling vehicle to move to the virtual buffer position
805 Virtual buffer position?
806 Access station available?
807 Instructing the container handling vehicle to move to the access station
808 Access station available?
809 Putting in virtual buffer?
810 Instructing the container handling vehicle to put the storage container in the virtual buffer

1. A method for moving a storage container with one of a plurality of container handling vehicles on a rail system arranged at least partially across a framework structure of an automated storage and retrieval system, on which the rail system and the plurality of container handling vehicles are operable to retrieve storage containers from, and deliver storage containers into, storage columns arranged in rows between upright members of the framework structure, and moving the storage containers to and from a port area of an access station, the method comprising, by a central control system which is in communication with the access station and a local controller in each of the plurality of container handling vehicles;
assigning a task to one of the plurality of the container handling vehicles to retrieve a storage container from one of the storage columns and deliver the storage container to the port area;
instructing the container handling vehicle to retrieve the storage container from the one of the storage columns;
determining a virtual buffer position on the rail system between the storage column and the port area;
instructing the container handling vehicle to move the storage container towards the virtual buffer position on the rail system;
repeatedly receiving data of a current position of the storage container on the rail system and a current availability of the access station;
instructing the container handling vehicle to move the storage container to a column of the port area if the current position of the storage container is different from the virtual buffer position and the column of the port area is available; and
instructing the container handling vehicle to deliver the storage container into the column of the port area.

2. The method of claim 1, wherein determining the virtual buffer position on the rail system comprises defining the virtual buffer position as any storage column within a first predetermined radius of one of the columns of the port area as the virtual buffer position.

3. The method of claim 1, wherein determining the virtual buffer position on the rail system comprises selecting a storage column close to the port area to be the virtual buffer position, wherein the storage column is one having space to receive the storage container.

4. The method of claim 1, wherein determining the virtual buffer position on the rail system comprises selecting the storage column closest to the port area having space to receive the storage container to be the virtual buffer position.

5. The method of claim 1, further comprising
instructing the container handling vehicle to move to a column of the access station if the current position of the storage container is in the virtual buffer position, and the column of the port area is available; and
instructing the container handling vehicle to deliver the storage container into the column of the port area.

6. The method of claim 1, further comprising determining, if the current position of the storage container is in the virtual buffer position and the access station is not available, instructing the container handling vehicle to deliver the storage container into the virtual buffer position.

7. The method of claim 2, further comprising determining, if the current position of the storage container is in the virtual buffer position and the access station is not available, instructing the container handling vehicle to deliver the storage container into an updated virtual buffer position other than the virtual buffer position.

8. The method of claim 6 further comprising instructing the container handling vehicle to deliver the storage container into the virtual buffer position when a deadline to deliver the storage container into a column of the port area exceeds a deadline threshold.

9. The method of claim 6 further comprising instructing the container handling vehicle to deliver the storage container into the virtual buffer position when the access station has been idle for a time exceeding an idle threshold.

10. Automated storage and retrieval system, comprising:
a framework structure comprising upright members;
a rail system arranged at least partially across the framework structure;
storage columns arranged in rows between the upright members of the framework structure;
an access station comprising a port area;
a plurality of container handling vehicles operable to retrieve storage containers from, and deliver storage containers into, the storage columns and moving the storage containers to and from the port area of the access station, each of the plurality of container handling vehicles comprising a local controller;
a central control system operable to be in communication with the access station and the local controller in each of the plurality of container handling vehicles the central control system adapted to
assign a task to one of the plurality of container handling vehicles to retrieve a storage container from one of the storage columns and deliver the storage container to the port area;
instructing the container handling vehicle to retrieve the storage container from the one of the storage columns;
determine a virtual buffer position on the rail system between the storage column and the port area;
instruct the container handling vehicle to move the storage container towards the virtual buffer position
repeatedly receive data of a current position of the storage container on the rail system and a current availability of the access station;
instruct the container handling vehicle to move the storage container to a column of the port area if the current position of the storage container is different from the virtual buffer position and the column of the port area is available; and
instruct the container handling vehicle to deliver the storage container into the column of the port area.

11. The system of claim 10, wherein the system is adapted to determine the virtual buffer position on the rail system by defining the virtual buffer position as any storage column within a first predetermined radius of one of the columns of the port area as the virtual buffer position.

12. The system of claim 10, wherein the system is adapted to determine the virtual buffer position on the rail system by selecting a storage column close to the port area to be the virtual buffer position , wherein the storage column is one having space to receive the storage container.

13. The system of claim 10, wherein the system is adapted to determine the virtual buffer position on the rail system by selecting the storage column closest to the port area having space to receive the storage container to be the virtual buffer position.

14. The system of claim 10, wherein the system is adapted to
instruct the container handling vehicle to move to a column of the access station if the current position of the storage container is in the virtual buffer, position and the column of the port area is available; and
instruct the container handling vehicle to deliver the storage container into the column of the port area.

15. The system of claim 10, wherein the system is adapted to determine, if the current position of the storage container is in the virtual buffer position and the access station is not available, to instruct the container handling vehicle to deliver the storage container into the virtual buffer position.

16. The system of claim 11, wherein the system is adapted to determine, if the current position of the storage container is in the virtual buffer position and the access station is not available, to instruct the container handling vehicle to deliver the storage container into an updated virtual buffer position other than the virtual buffer position.

17. The system of claim 16, wherein the system is adapted to instruct the container handling vehicle to deliver the storage container into the virtual buffer position when a deadline to deliver the storage container into a column of the port area exceeds a deadline threshold.

18. The system of claim 16, wherein the system is adapted to instruct the container handling vehicle to deliver the storage container into the buffer position when the access station has been idle for a time exceeding an idle threshold.

19. Computer program product for a central control system as recited in claim 10, wherein the computer program product comprises instructions that when performed on the central control system performs a method as recited in claim 1.
